(19) United States
(12) Patent Application Publication
(10) Pub. No.: US 2021/0148545 A1
(43) Pub. Date: May 20, 2021

(54) ANTIREFLECTIVE OPTICS FOR LIGHTING PRODUCTS

(71) Applicant: Glint Photonics, Inc., Burlingame, CA (US)

(72) Inventors: Andrew Kim, San Jose, CA (US); Peter Kozodoy, Palo Alto, CA (US); John Lloyd, San Mateo, CA (US); Christopher Gladden, San Mateo (US)

(21) Appl. No.: 17/100,138

(22) Filed: Nov. 20, 2020

Related U.S. Application Data
(60) Provisional application No. 62/937,788, filed on Nov. 20, 2019.

(51) Int. Cl. F21V 9/00; G02B 5/28; F21V 8/00

(52) U.S. Cl. CPC F21V 9/00; G02B 5/28; F21Y 2115/10; G02B 6/0051; G02B 2207/101; G02B 6/004

(57) ABSTRACT

Application of antireflective surfaces of various types on lighting fixture or lamp optical components.

### CROSS REFERENCE TO RELATED APPLICATIONS

This application claims priority to a co-pending U.S. Provisional Patent Application Ser. No. 62/937,788 filed Nov. 20, 2019 entitled “Antireflective optics for lighting products”, the entire contents of which are hereby incorporated by reference.

### TECHNICAL FIELD

This patent relates to optics, specifically to optical structures for lighting products.

### BACKGROUND

Lighting fixtures and lamps often employ a wide range of optical elements including lenses, waveguides, cover windows, diffusers, and more. Each of these elements has one or more faces where light enters and/or exits the element. At each such entry or exit face, the light transits between two different refractive indices—typically a refractive index of 1 in air and a refractive index between 1.3 and 1.7 in the optical element. This change in refractive index will result in a portion of the light being reflected, which is called a Fresnel reflection. Depending on refractive index and angle of incidence, the magnitude of the Fresnel reflection at a given face is typically 4% to 6%. The Fresnel-reflected light will travel a different path within the lighting fixture than the remainder of the light. Some of it may ultimately be absorbed within the lighting fixture, in which case the presence of the Fresnel reflection results in a reduction in efficiency for the fixture. Some of it may ultimately exit the fixture at an undesirable emission angle, in which case it is creating undesirable glare. Therefore, reducing the magnitude of Fresnel reflections is desirable in order to increase the efficiency of lighting fixtures and reduce their glare. This can be achieved with an antireflective coating applied to the entry and/or exit faces of some or all of the optical elements.

An ideal anti-reflective (AR) coating for lighting applications provides a low reflectivity across the full range of light wavelengths of interest (typically around 400 nm to 750 nm for visible light), and across as wide as possible a range of incident light angles. Further, an ideal anti-reflective coating is low-cost, easy-to-apply, robust and durable, and does not alter the color of the transmitted light or present a colored appearance when viewed at different angles.

Antireflective nanostructure (ARN) materials have been studied for many years. Such surfaces contain texturing on a size-scale below the wavelength of visible light, with the structure often resembling conoids or pillars. Such surfaces create an effective gradient refractive index at the transition between solid material and air, greatly reducing the Fresnel reflections that result from abrupt transitions at smooth interfaces. This sort of texturing is often called a “moth-eye” pattern because it mimics the natural structures found in the eyes of moths. FIG. 1 (a) shows an example of a moth-eye type anti-reflective nanostructured surface 30, wherein a polymer material 10 has a dense array of conoid structures at the interface between the polymer and air 11. FIG. 1(b) shows an example where the nanostructured surface 30 is formed with pillar shapes. These are example structures, and many other structure types are possible. In all cases, however, the characteristic dimension 15 is smaller than the wavelength of visible light (i.e. smaller than ˜420 nm). These structures are typically produced by imprinting, embossing or molding from a master pattern.

Recently, ARN films have become available on the commercial market. FIG. 2 (a) shows such a film 20 adhered to the face of an optical element 8. The film 20 contains a transparent layer 21 with ARN surface 30. It also contains a support substrate 22 made of a transparent polymer film. An optically-clear adhesive (OCA) layer 23 is used to attach the film to the face of optical element 8.

Other ways to impart antireflective properties to an optical element are also known in prior art. One method is the deposition of a layer with refractive index intermediate between the air (n=1) and the optical material on which it is deposited. Such layers may be made of a low-index material such as MgF₂, or porous silica. The layer may be deposited using techniques such as vapor deposition or solution deposition. Through the use of appropriate techniques, the porosity of such a deposited layer may be made to vary through its thickness, creating an effective gradient index to further reduce reflectivity.

Another method of prior art is to deposit multilayer dielectric stacks that use optical interference to achieve antireflective properties. Such stacks use alternating layers of high-refractive-index and low-refractive-index materials of precisely controlled thickness, and are typically deposited using vapor deposition processes.

Antireflective surfaces formed in any of these ways may be deposited directly onto an optical element, or deposited onto a transparent film that may then be adhered to the optical element.

### SUMMARY

This patent describes the application of antireflective surfaces of any type on various lighting fixture or lamp optical components.

In accordance with one embodiment, a lighting fixture comprises a lightguide with scattering features and with one or more input edges that receive light from one or more light sources. An antireflective structured film is applied to one or more of the input edges.

In another embodiment, one or more optical elements are arranged to receive light from one or more light sources. The optical elements may comprise a pair of facing substrates. At least one optically-adjustable material is disposed between the substrates. Anti-reflective surfaces are disposed on the outside faces of the substrates.

### BRIEF DESCRIPTION OF THE DRAWINGS

A further understanding of the nature and advantages of the present invention may be realized by reference to the remaining portions of the specification and the drawings.

FIG. 1 (a) is a perspective view of an example moth-eye structured surface with conoid structures.

FIG. 1 (b) is a perspective view of an example moth-eye structured surface with cylindrical pillar structures.

FIG. 2 (a) is a cross-section view of an optical element covered by a film containing an ARN layer.

FIG. 2 (b) is a cross-section view of an optical element covered by an ARN layer with adhesive.

FIG. 2 (c) is a cross-section view of an optical element covered by an ARN layer.

FIG. 2 (d) is a cross-section view of an optical element with an ARN layer formed in its surface.

FIG. 2 (e) is a cross-section view of an optical element with a complex surface shape and an ARN layer formed in its surface.

FIG. 3 is a cross-section view of a light engine with a lens that is provided with AR surfaces.

FIG. 4 is a cross-section view of a light engine with a reflective lens that is provided with an AR surface.

FIG. 5 is a cross-section view of a light engine with a TIR lens that is provided with AR surfaces on its input and output faces.

FIG. 6 is a perspective view of a light engine with a lightguide that is provided with AR surfaces on its input and output faces.

FIG. 7 is a perspective view of a light engine with a scattering lightguide that is provided with an AR surface on its input edge.

FIG. 8(a) is a perspective view of a light engine with a scattering lightguide and cutouts for light input, with AR surfaces on its input faces.

FIG. 8(b) is a cutaway perspective view of a light engine with a scattering lightguide and cutouts for light input, with AR surfaces on its input faces.

FIG. 9 is a cross-section view of a light engine with a variable lens that is provided with AR surfaces on its input and output faces.

FIG. 10 is a cross-section view of a light engine with a window that is provided with AR surfaces on its input and output faces.

FIG. 11 is a cross-section view of a light engine with a diffuser that is provided with AR surfaces on its input and output faces.

FIG. 12 is a cross-section view of a light engine with a TIR lens and a diffuser, with AR surfaces on the input and output faces of both the TIR lens and the diffuser.

FIG. 13 is a cross-section view of a light engine with a focusing reflector and a window, with AR surfaces on the input and output faces of the window.

FIG. 14 is a perspective view of a light engine with an extended linear light source and a tubular window surrounding it, with AR surfaces on the input and output faces of the window.

FIG. 15 is a cross-section view of a light engine with an array of light sources, an optical element with a corresponding array of lenses, and a window, with AR surfaces on the input and output faces of the lenses as well as the input surface of the window.

FIG. 16 is a cross-section view of a light engine with an array of light sources, a corresponding array of TIR lenses, and a diffuser, with AR surfaces on the input and output surfaces of the TIR lenses as well as the input face of the diffuser.

FIG. 17 is a cross-section view of a light engine with a light source, a focusing reflector, a movable focusing lens, and a window, with AR surfaces on the input and output faces of the lens as well as the input face of the window.

FIG. 18 is a cross-section view of a catadioptric light engine with a light source, a reflective lens, and a focusing lens, with AR surfaces on the input and output faces of the lens as well as the input face of the reflective lens.

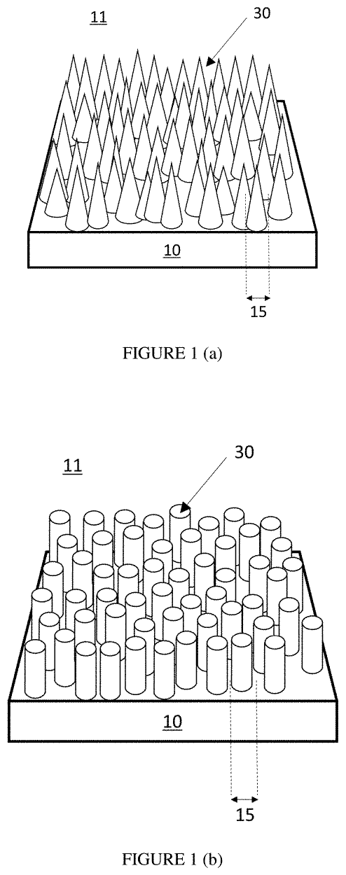

### DESCRIPTION OF PREFERRED EMBODIMENTS

Lighting fixtures or lamps utilize light engines, which consist of light sources and optics that distribute and shape the light. The descriptions below describe various light engine designs that incorporate optical elements with antireflective (AR) surfaces that can be implemented in lighting fixtures or lamps.

The AR surfaces in these embodiments are generally denoted with element 12 and may be formed in various ways. The AR surface may be formed from nanostructures, from multilayer films using interference effects, from porous materials, from materials with an intermediate refractive index, or other anti-reflective technologies. Further, the AR surface may be formed directly on the optical element or on a transparent film that is adhered to the face of the optical element.

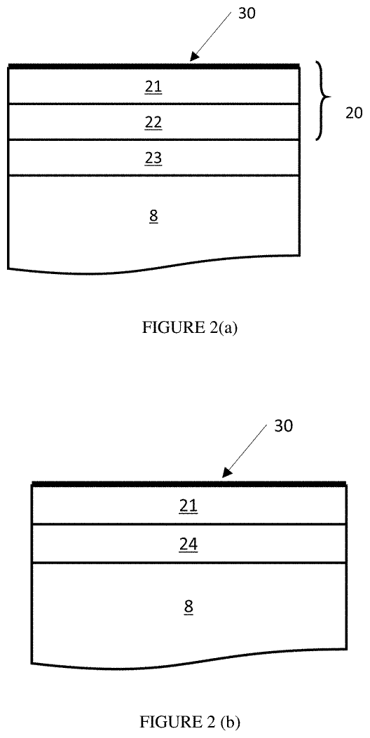

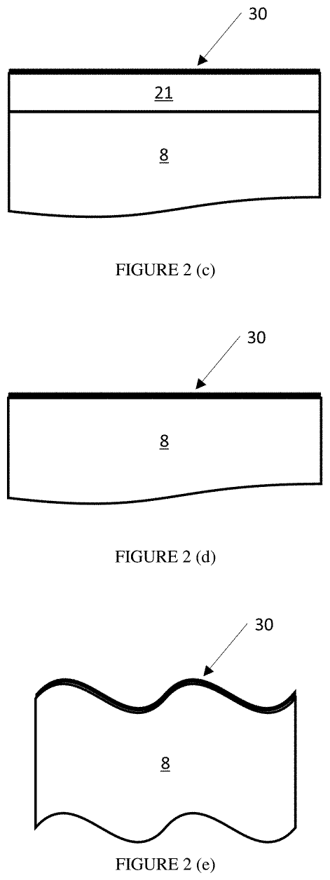

If the AR surface is formed using nanostructures, it may be implemented using a commercially-available ARN film as shown in FIG. 2(a). Antireflective structured surfaces may also be formed in other ways on optical elements. FIG. 2(b) shows a case in which a transparent layer 21 with ARN surface 30 is attached directly to the face of an optical element 8 using transparent adhesive layer 24, without a support substrate. The adhesive layer 24 may be a pressure-sensitive adhesive, a liquid curable adhesive, or another adhesive material.

FIG. 2(c) shows a case in which a transparent layer 21 with ARN surface 30 adjoins the face of optical element 8 without any intermediate layers. Such a structure can be formed, for example, by coating the optical element 8 with a layer 21 of formable material which is cured in a mold or compression-stamped to create the ARN surface 30.

FIG. 2(d) shows a case in which the optical element 8 is itself formed to have an ARN surface 30. This case requires no intermediate layers. The ARN surface 30 can be formed as part of the optical element 8 by various means, for example injection molding or compression molding.

FIGS. 2(a) through 2(d) show the ARN surface 30 and the face of optical element 8 both as flat. However, the surfaces may also be curved, faceted, undulating, or varying in other ways. As an example, FIG. 2(e) shows an optical element 8 with a complex face profile and the ARN layer 30 conforming to the face of the optical element 8. In general, it is desirable that the layers 21, 22, 23, and 24 all be thin compared to the optical element 8, and that the antireflective structured surface 12 follows the contours of the face of the optical element 8 to the extent possible. We note that the different implementations of the ARN surface shown in FIGS. 2(a) through 2(d) may differ in their ability to follow the surface contours of specific optical elements. For example, the film 20 shown in FIG. 2(a) is limited in its ability to follow complex face curvatures as the support substrate 22 has limited ability to stretch.

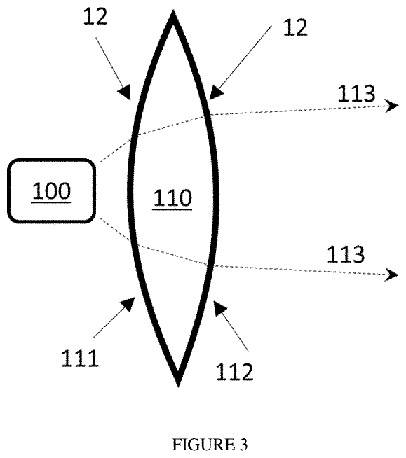

FIG. 3 shows a light engine in which a lens 110 receives and transmits light 113 from a light source 100. The light source 100 may be one or more light-emitting diodes (LEDs), a chip-on-board (COB) source containing multiple LEDs, or a variety of other light sources. The lens 110 is preferably made of a transparent material such as glass or a polymer such as acrylic or polycarbonate. It features an input face 111 and an output face 112. AR surfaces 12 are present on both the input optical face 111 and the output optical face 112. Alternatively, the AR surface may be implemented on only one of the optical faces 111, 112. FIG. 3 shows a double-convex lens 110, but the lens may also be meniscus, double concave, or feature one plano face. Further, the lens may feature other, more complex shapes.

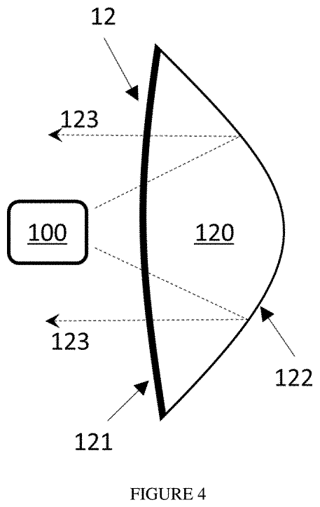

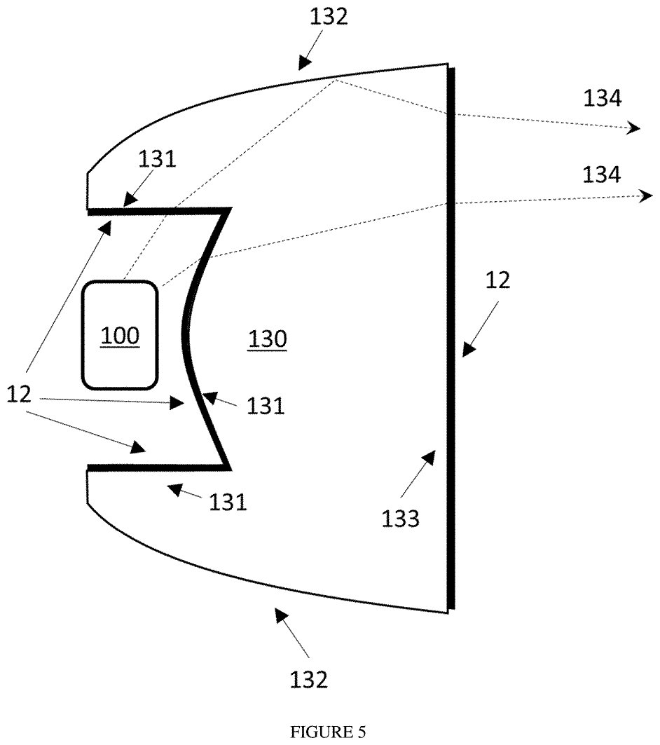

FIG. 4 shows a light engine utilizing a reflective lens 120, in which light 123 from a source 100 enters and exits the lens through the same face 121, undergoing a reflection at the reflective face 122 while within the lens. Face 121 is coated with an AR surface 12, which provides anti-reflective benefit twice from the same application of AR surface 12 as light 123 enters and exits the same face 121.

FIG. 5 shows a light engine utilizing a total-internal-reflection (TIR) optic 130 that includes one or more input faces 131 surrounding the light source 100, an inclined peripheral face 132 that provides total internal reflection, and one or more output faces 133. Such TIR lenses are often rotationally symmetric about the central optical axis, but need not be. Light 134 enters an input face 131 and transits the optic 130 before exiting the output face 133. While transiting the optic 130, some of the light 134 reflects off the inclined face 132. AR surfaces 12 are applied to the input faces 131 and the output face 133. Alternatively, AR surfaces 12 may be applied to only one of these faces.

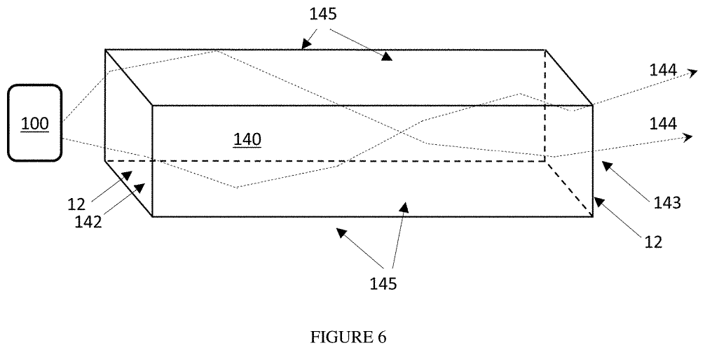

FIG. 6 shows a light engine utilizing a lightguide 140. A light source 100 is adjacent to an input face 142 of the lightguide 140. Light 144 that enters the lightguide is confined by total internal reflection at the sides 145 of the lightguide, and exits through face 143. An AR surface 12 is applied to the input face 142 and the output face 143 of the lightguide. FIG. 6 shows a rectangular lightguide but lightguides of various shapes may be utilized.

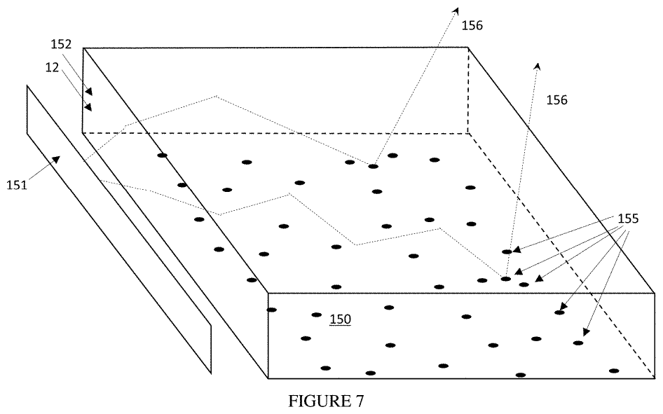

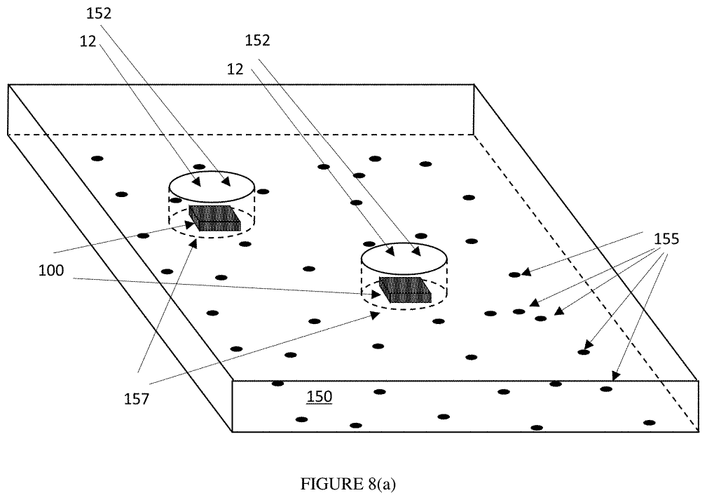

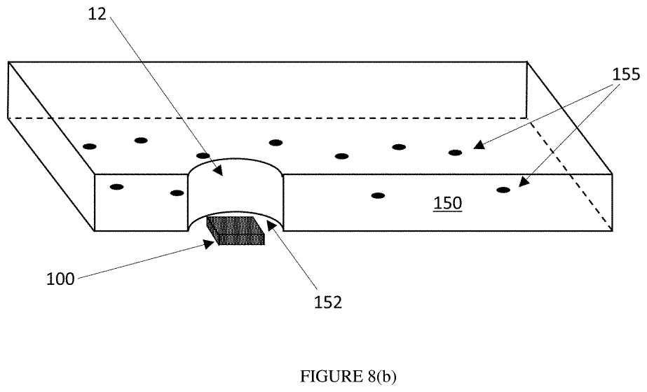

FIG. 7 shows a light engine utilizing a lightguide 150 with scattering features 155. The light source 151 is adjacent to an input face 152 of the lightguide 150. The light source 151 may be a linear array of LEDs, a fluorescent tube light, or another type of light source. Light 156 that enters the lightguide is confined by total internal reflection, until it encounters a scattering feature 155. The scattering features may be of many types that exist in the prior art, including embedded light-scattering materials within the lightguide or on a face of the lightguide, or a roughened surface on the lightguide. An AR surface 12 is applied to the input face 152 of the lightguide. AR surfaces may also optionally be applied to the other faces of the lightguide. FIG. 7 shows a flat rectangular lightguide, but lightguides of various shapes, including flat circular lightguides, may be utilized. The input face 152 may be at the perimeter of the lightguide or may be placed elsewhere. For example, FIG. 8(a) shows a lightguide 150 featuring thru-holes 157 that surround light sources 100. AR surface 12 is applied to the interior walls of the holes 157, which are the input faces 152 through which light enters the lightguide 150 from the light sources 100. FIG. 8(b) shows a view of the same embodiment as a cutaway passing through one of the holes 157.

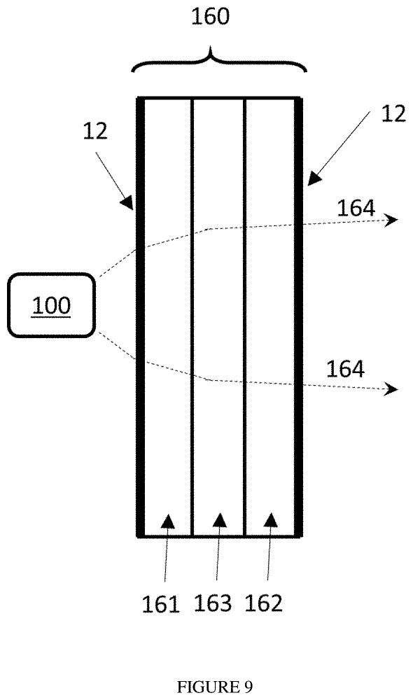

FIG. 9 shows a light engine using a lens 160 containing optically-adjustable materials held between two substrates facing each other. The lens 160 features transparent substrate 161 and transparent substrate 162 with adjustable optical materials 163 located between them, adjacent their inside faces. The adjustable optical materials 163 may include liquid crystal materials, optical liquids, or other materials. AR surfaces 12 are present on the outside faces of transparent substrates 162 and 163. Light 164 from the light source travels through the lens 160.

Light engines may also contain a window layer to protect the internal light source and/or optics. AR surfaces may be applied to such window layers to reduce reflections.

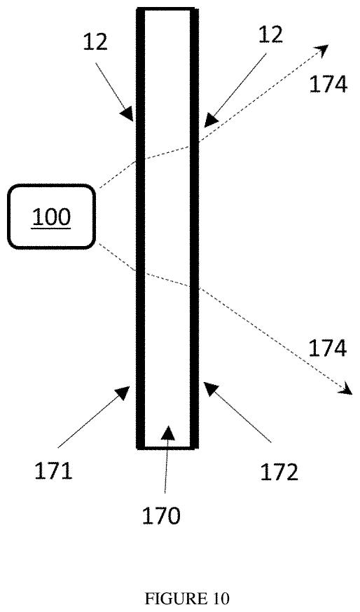

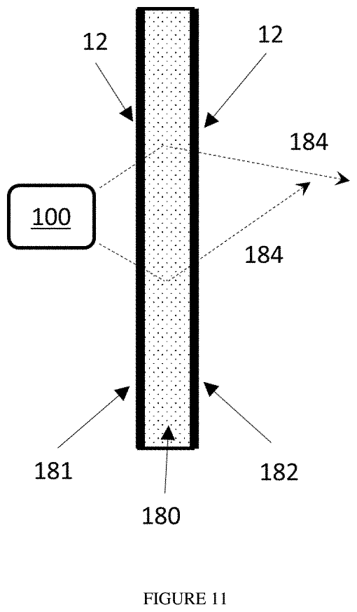

FIG. 10 shows an example light engine with a transparent window 170 with faces 171 and 172. Light 174 travels from the light source 100 through the window 170. Both faces 171 and 172 are coated with AR surfaces 12. Alternatively, only one face 171 or 172 may be so coated. The window may be flat, as shown in FIG. 10, or have another shape, for example tubular or domed.

Many light engines contain a diffuser to spread light and/or visually hide the light source. Light 184 travels from the light source 100 through the diffuser 180. Diffusers may spread light by having one or more rough surfaces, or by including light-scattering materials within the diffuser itself, or both. AR surfaces may be applied to all such diffusers to reduce reflections. FIG. 11 shows a light engine utilizing a diffuser 180 with faces 181 and 182. Both faces 181 and 182 are provided with AR surfaces 12, or optionally only one face may be so provided.

We note that the designs in FIGS. 3 through 11 can be combined together in many different combinations, and combined with other optics, to create different light engines. Indeed, AR surfaces may be especially valuable in light engines with multiple optical faces, which typically result in significant efficiency loss and glare light.

Some examples of systems are provided below.

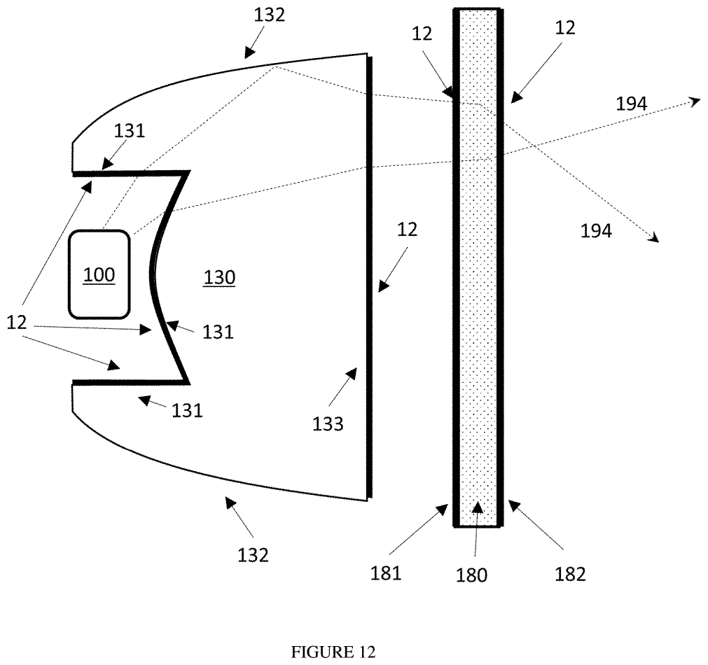

FIG. 12 shows a light engine in which light 194 from a light source 100 travels through a TIR optic 130 and an accessory diffuser 180. AR surfaces 12 are implemented on the input and output faces of both the TIR optic 130 and the accessory diffuser 180. Alternatively, only some of these faces could feature AR surfaces.

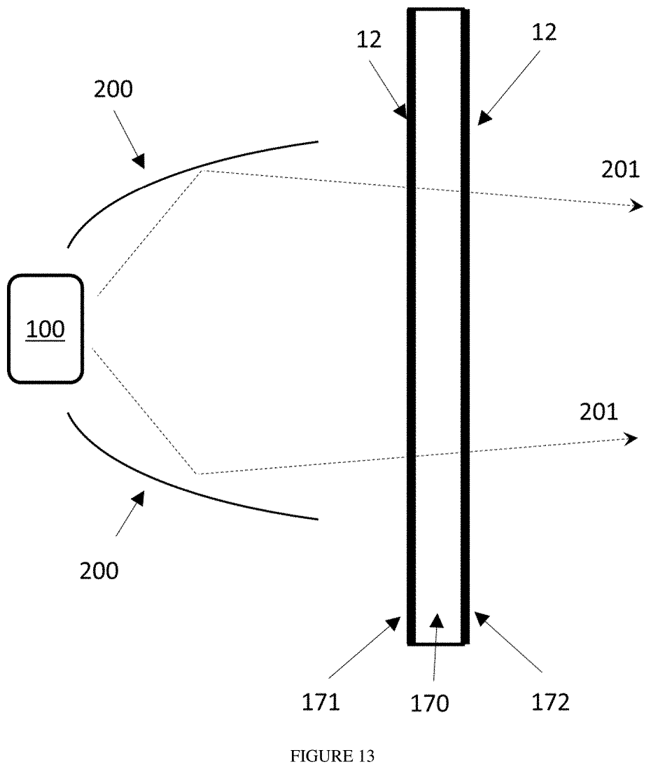

FIG. 13 shows a light engine in which light 201 from a light source 100 is reflected by a focusing reflector 200 and then transits a transparent window 170 that has AR surfaces 12 on both sides in order to reduce unwanted reflections—that is, back through the reflector 200.

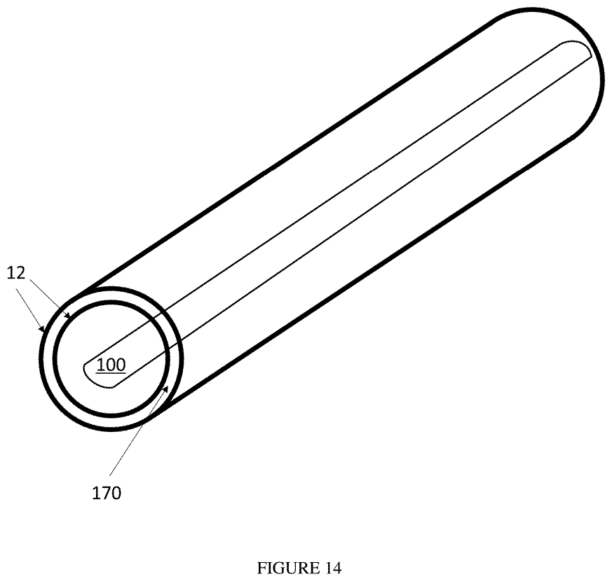

FIG. 14 shows a tubular light engine, such as used for tubular fluorescent lamps and LED-based replacements for fluorescent tubes. It features a cylindrical cover window 170 with AR surfaces 12 on both the input and output faces. The cover window 170 surrounds an extended light source 100 that may be a linear array of LEDs or another extended light source. The cylindrical cover window 170 may optionally be replaced with a cylindrical cover diffuser featuring AR surfaces on the input and/or output faces.

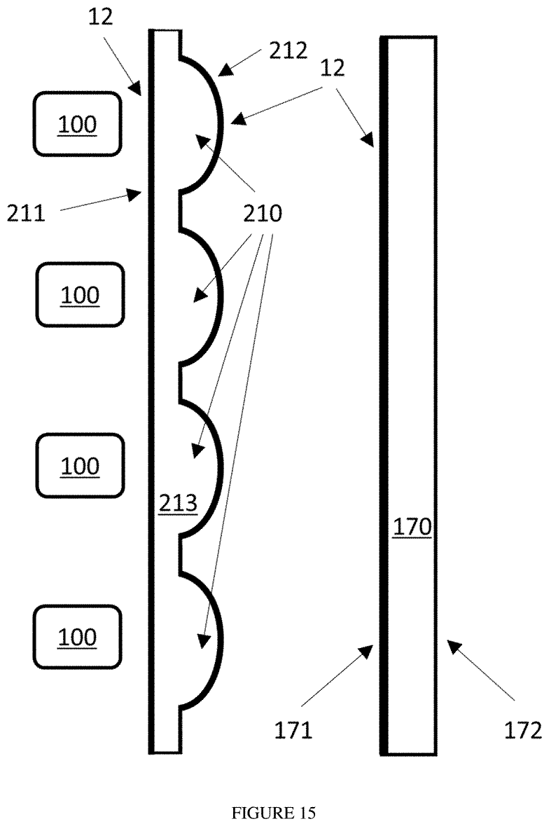

FIG. 15 shows a light engine with an array of light sources 100 and an optical element 213 that contains an array of lenses 210, such that each light source 100 is associated with a lens 210. A cover window 170 encloses the light engine. This and similar designs may be used in streetlights and other lighting fixtures. In this example, AR surfaces 12 are implemented on the input face 211 and output face 212 of the optical element 213, and on the input face 171 of the window 170.

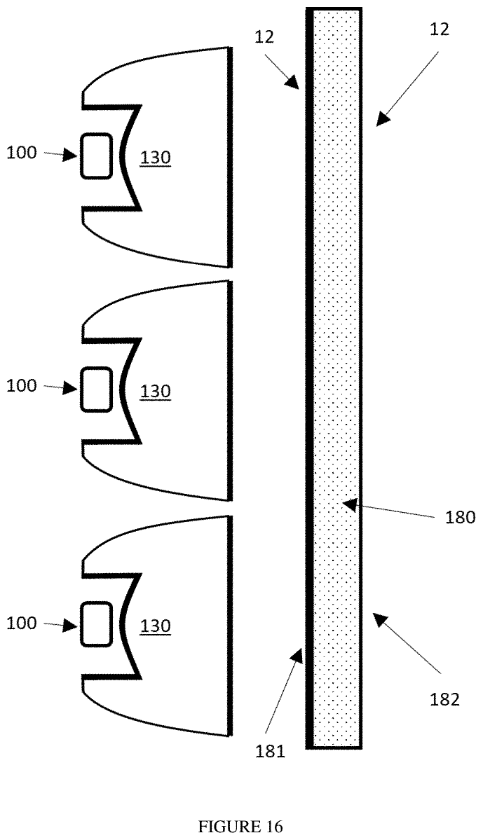

FIG. 16 shows a light engine featuring an array of light sources 100 and a corresponding array of TIR lenses 130, with a single diffuser element 180 spreading the light from the various TIR lenses. In this example, AR surfaces are provided on both the input faces 131 and output faces 133 of the TIR lenses, and the input face 181 of the diffuser 180.

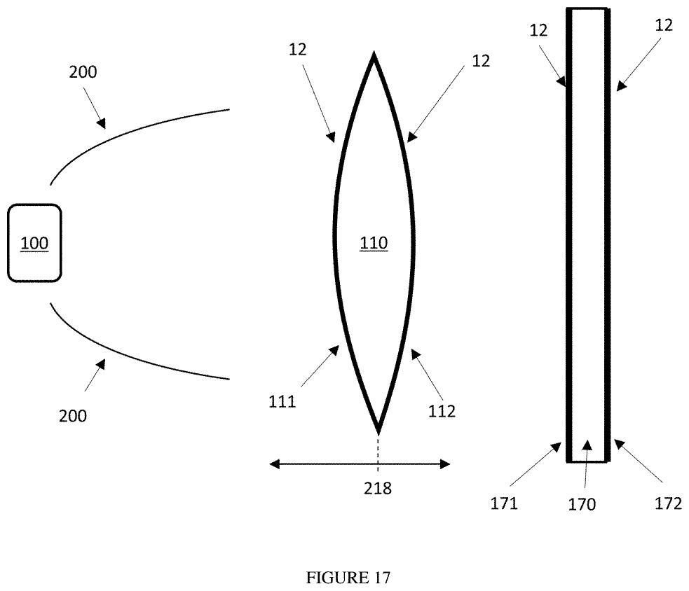

FIG. 17 shows a light engine for producing directional light with adjustable beam width. It features a light source 100, a focusing reflector 200, and a focusing lens 110 whose position 218 can be adjusted to adjust beam width. A cover window 170 protects the moving mechanism. AR surfaces 12 are implemented on both the input face 111 and the output face 112 of the lens 110, and both the input face 171 and output face 172 of the cover window 170.

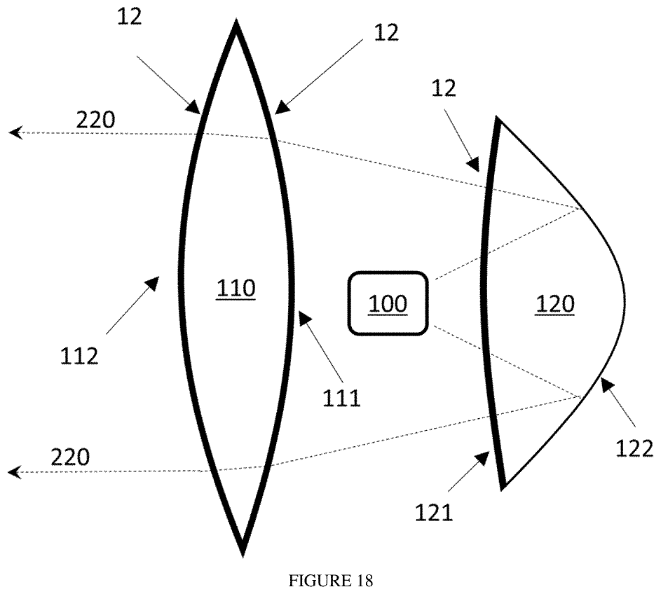

FIG. 18 shows a light engine utilizing a catadioptric design. Light 220 from light source 100 enters reflective lens 120 through face 121, is partially focused by reflector surface 122 and exits the reflective lens by passing again through face 121. The light then passes through lens 110 to become further focused. AR surfaces are implemented on both the input face 111 and the output face 112 of lens 110 as well as face 121 of reflective lens 120.

These examples are not exhaustive, and other useful implementations of the AR surfaces within luminaire light engines will be evident to those skilled in the art.

What is claimed is:

1. A lighting fixture comprising one or more light sources and one or more optical elements, wherein the optical elements feature one or more optical faces at which light transits between air and the material of the optical elements, and wherein one or more of the optical faces are provided with an antireflective surface.

2. The apparatus of claim 1 wherein the antireflective surface comprises antireflective nanostructures.

3. The apparatus of claim 1 wherein the antireflective surface comprises a multilayer dielectric stack providing optical interference.

4. The apparatus of claim 1 wherein the antireflective surface comprises a porous material.

5. The apparatus of claim 1 wherein the antireflective surface comprises a material having intermediate refractive index between that of the optical element and that of air.

6. The apparatus of claim 1 wherein the antireflective surface comprises a film with antireflective properties that is adhered to the optical element.

7. The apparatus of claim 1 wherein the optical element comprises a lightguide with scattering features and the antireflective surface is provided on the input face of the lightguide adjacent to the light source.

8. The apparatus of claim 1 wherein the optical element comprises a TIR lens and the antireflective surface is provided on at least one of the input face of the lens and the output face of the lens.

9. The apparatus of claim 1 wherein the optical element comprises an array of one or more lenses and the antireflective surface is provided on at least one of the input face of the lenses and the output face of the lenses.

10. The apparatus of claim 1 wherein the optical element comprises one or more reflective lenses and the antireflective surface is provided on at least one of the input face of the lenses and the output face of the lenses.

11. The apparatus of claim 1 wherein the optical element comprises a window and the antireflective surface is provided on at least one of the input face of the window and the output face of the window.

12. The apparatus of claim 1 wherein the optical element comprises a diffuser and the antireflective surface is provided on at least one of the input face of the diffuser and the output face of the diffuser.

13. The apparatus of claim 1 wherein the optical element comprises a variable lens and the antireflective surface is provided on at least one of the input face of the lens and the output face of the lens.

14. The apparatus of claim 1 wherein the light source comprises one or more light emitting diodes.

15. The apparatus of claim 1 wherein the one or more optical elements further comprise a reflective surface, and the reflective surface is further arranged for receiving light from optical face and reflecting such received light back towards the optical face.

16. A lighting apparatus comprising:
a light source;
a transmissive surface;
a reflective lens, arranged to receive light from the light source trough the transmissive surface, and reflect the light back towards the transmissive surface; and
an anti-reflective coating disposed on the transmissive surface.

17. A lighting apparatus comprising:
one or more light sources;
one or more optical elements, arranged to receive light from the one or more light sources, and wherein each the optical elements comprise a pair of facing substrates, each substrate having respective inside and outside faces, with at least one optically-adjustable material disposed between the inside faces of the pair of substrates, and further wherein anti-reflective surfaces are disposed on the outside faces of the pair of substrates.
